(19) United States
(12) Patent Application Publication
(10) Pub. No.: US 2002/0191587 A1
(43) Pub. Date: Dec. 19, 2002

(54) Communication system

(76) Inventors: Roger Wong, Calgary (CA); Alex Chan, Calgary (CA)

Correspondence Address: BORDEN LADNER GERVAIS LLP, WORLD EXCHANGE PLAZA, 100 QUEEN STREET SUITE 1100, OTTAWA, ON, K1P 1J9, CA

(21) Appl. No.: 09/883,395

(22) Filed: Jun. 19, 2001

(51) Int. Cl. H04J 3/16

(52) U.S. Cl. 370/352; 370/465; 709/218; 709/219; 709/249

(57) ABSTRACT

The invention relates to a communications system which provides enhanced voice and data communications over the internet between users either at or remote to their local computer and other users or specific services over the internet.

### FIELD OF THE INVENTION

The invention relates to a communications system which provides enhanced voice and data communications over the internet between users either at or remote to their local computer and other users or specific services over the internet.

### BACKGROUND OF THE INVENTION

The increasing usage of the internet and the need to leverage different competing communications channels has created a market for devices that help achieve a unified communications environment.

Phone to phone over the internet is a developing technology. First generation systems products which provided elementary computer to computer voice communications using voice over IP (VoIP) have been developed. These systems convert analog voice signals to digital data packets and transmit these data packets effectively over internet protocol (IP) networks. This first generation technology has been possible by a combination of established network equipment, supplier, hardware companies and phone companies providing long distance service at minimal or no cost. However, first generation technology while generally appealing to high end users willing to pay for early generation equipment as well as early adopting consumers willing to accept inconsistent service, has been limited by the levels of service offered by first generation hardware/software suppliers and service companies. A drawback of first-generation technology is that users must be in front of their computers to make a phone call.

Accordingly, there has been a need for voice over IP products which address the problems of the first generation technologies. Specifically, there has been a need for hardware/software products which provide the functionality and reliability demanded by a broader spectrum of consumers for voice over IP. That is, there has been a need for products which, in addition to competing with the services of the regular telephone network service providers provides additional features, capabilities and services which are not provided by the regular telephone network service providers.

In particular, there has been a need for additional features in voice over IP products which appeal to a broad range of internet users including individual or family computer/internet users of all ages and/or businesses with a high long distance call demand. In addition, there has been a need for internet access products for users who are frequently away from their local computer and who require regular internet data.

That is, there has been a need for products which allow a user to remotely access their base computer to initiate internet phone calls or to obtain internet data from websites. In addition, there has been a need for hardware and software functionality which allows a user to remotely access their email or stock quotes over any phone by dialing a single number and using text to voice conversion.

### SUMMARY OF THE INVENTION

In accordance with the invention, there is provided a communications system enabling voice communications over the internet between a local or remote phone and a destination phone comprising:

an internet protocol (IP) phone controller for operative connection to the local and remote phone and a computer operatively connected to the internet, the computer having communications software for managing voice over internet protocol communications between the local and remote phone and a destination phone through the phone controller.

In accordance with another embodiment, the invention provides a method for making a voice over internet protocol telephone call to a destination number from a remote telephone comprising the steps of:

a) dialling a phone number for an internet protocol (IP) phone controller operatively connected to a computer and the internet;

b) accessing an internet phone provider through the IP phone controller and computer; and,

c) dialling the destination number from the remote telephone.

In a still further embodiment, the invention provides a method for obtaining internet data from a remote telephone comprising the steps of:

a) dialling a phone number for an internet protocol (IP) phone controller operatively connected to a computer and the internet;

b) accessing an internet data provider through the IP phone controller and computer; and,

c) instructing the internet data provider to download data to the computer.

In a more specific embodiment, the invention provides a communications system enabling voice communications over the internet between a local or remote phone and a destination phone comprising:

an internet protocol (IP) phone controller for operative connection to the local and remote phone;

a computer operatively connected to the internet, the computer having communications software for managing voice over internet protocol communications between the local and remote phone and a destination phone through the phone controller, the communications software having:

a menu system module, the menu system module enabling a user to select an internet phone provider and to dial a destination number after selection of an internet phone provider;

access to formatted internet data and delivery of the data to the user via a text-to-speech module,

wherein the destination phone is any one of a local or remote phone operatively connected to a destination IP phone controller and destination computer operatively connected to the internet or a wireless or wired destination phone operatively connected to the internet through a public switched telephone network.

### DESCRIPTION OF THE DRAWINGS

These and other features of the invention are described with reference to the drawings wherein:

FIG. 1 is a schematic overview of the communications system in accordance with the invention;

FIG. 2 is a schematic diagram of the hardware modules of the IP phone controller box in accordance with the invention;

FIG. 3 is a schematic overview of the loading and main program flowchart in accordance with the invention;

FIG. 4 is a schematic overview of a menu system in accordance with the invention;

FIG. 5 is a schematic overview of a text-to-speech flowchart in accordance with the invention;

FIG. 6 is a schematic overview of an incoming telephone call flowchart in accordance with the invention; and,

FIG. 7 is a schematic overview of a Voice over IP object flowchart in accordance with the invention.

### DETAILED DESCRIPTION OF THE INVENTION

System Overview

In accordance with the invention and with reference to the figures, a system 10 is described which provides enhanced voice and data communications over the internet between users either at or remote to their local computer and other users or specific services over the internet.

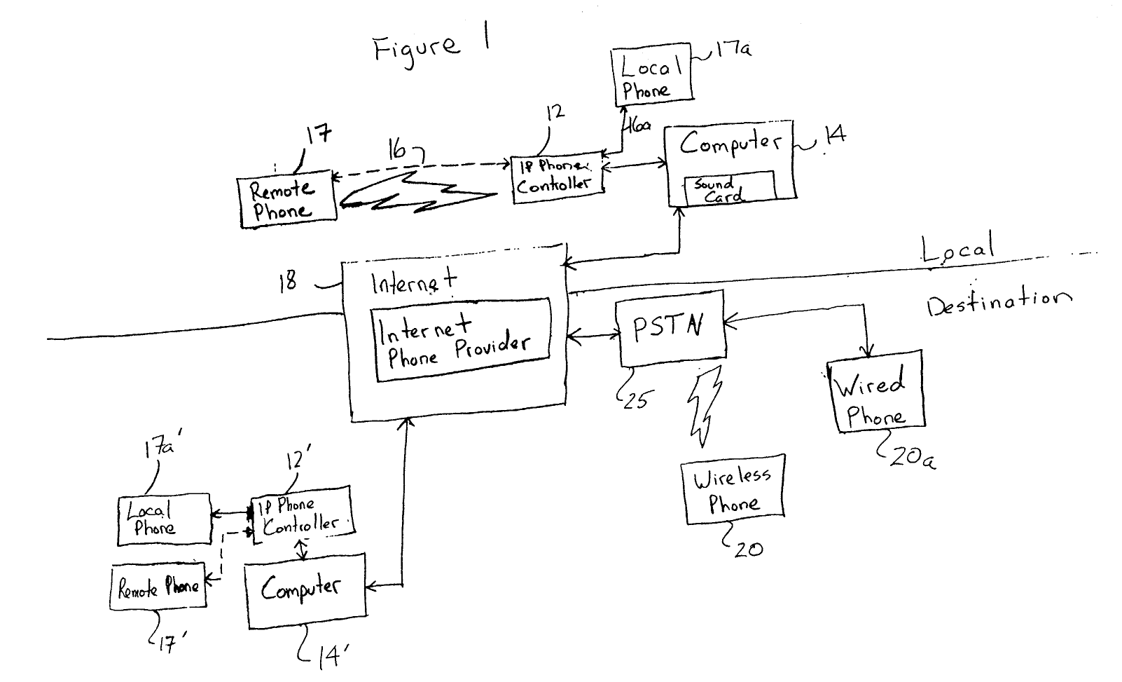

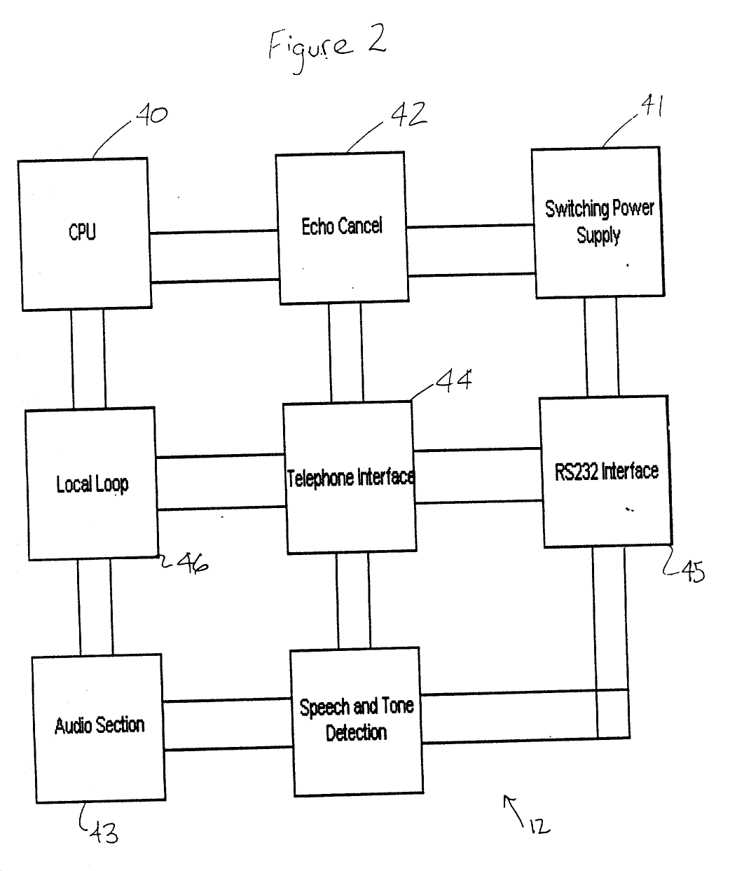

As shown in FIG. 1, the system includes an IP Phone Controller box (PCB) 12 operatively connected to a computer 14 and phone lines 16 and 16a connected to remote telephone 17 and local telephone 17a, respectively. The computer 14 is operatively connected to the internet 18. The PCB 12 includes hardware enabling amongst other functions, PCB system control, speech and tone detection and appropriate telephone interfaces (FIG. 2).

The system also includes software resident with computer 14 for interfacing with the PCB 12 and for providing control functionality of voice and data communications as well as display and input functionality for users.

As an overview of the use of the system, the system enables a remote user to access the internet using a remote phone 17 or local phone 17a to place an internet telephone call or to retrieve information from the internet such as from an internet website.

An internet telephone call would generally proceed as follows:

1. A user wishing to make a voice call over the internet would initiate the call to a destination number from a either a remote telephone 17 or local telephone 17a through a local PCB 12 by dialing the PCB local number. The remote telephone 17 may be any telephone connected to a telephone network which can dial to a specific number assigned to the local location. The local telephone 17a would have the local number.

2. After establishing contact with the PCB 12 and gaining authorization to initiate a call, a destination number would be dialed. After establishing a link with the destination phone 17′, 17a′, 20 or 20a, the voice call from either the remote 17 or local phone 17a is digitized and compressed and converted to data packets by an internet phone provider and routed back to the PCB through a sound card in computer 14.

3. The data packets are routed over the internet to the destination number.

4. The packets arrive at the destination and are reassembled into a voice signal by a destination public switched telephone network (PSTN) 25 or a similar PCB 12′ at the destination having locally installed VoIP software;

5. If the destination number is accessed through the destination PSTN 25, the analog voice signal is transmitted through the local PSTN to the end-receiver phone 20 or 20a. Alternatively, if the destination includes an PCB 12′, the data packets are reassembled by the locally installed VoIP software PCB 12′ and delivered directly to a destination phone 17a′.

A user may access data from an internet website as follows:

1. As for an internet telephone call, a user wishing to obtain data from a website would initiate the call to the local PCB 12 from a either a remote telephone 17 or local telephone 17a. In most circumstances, the data collection would be initiated from the remote telephone 17.

2. After establishing contact with the PCB 12 and gaining authorization to initiate data capture from a website, the PCB12 software instructs the computer 14 to download data from the website to the computer 14.

3. Specific formatting scripts in the computer software convert the data to specific formats.

4. The formatted data is accessed by the user through a voice menu and response system wherein the data is converted to an audio format which is read to the user at the remote location using known text to speech software.

An internet telephone call using the system described above will incur no direct costs, other than internet access fees, if the destination number has a similar PCB 12′. Minimal fees will be incurred if the destination number must be accessed through a PSTN 25 which will require the caller to have a membership with an internet phone provider.

IP Phone Controller Box 12 (FIG. 2)

The PCB 12 is a telephone to computer switching apparatus which includes a number of circuit modules providing operative connection between a local telephone 17a, a remote phone 17 and a host computer 14. The PCB 12 includes a central processing unit (CPU) 40 for providing the basic processing power of the PCB and power supply 41 for electrical energy. An echo cancellation module 42 processes the input and output audio signals and prevents speaker feedback to the microphone as is known. The PCB 12 also includes a telephone interface 44 for operative connection to a local telephone network, a local loop 46 for connection to a local phone 17a and an RS232 interface 45 for connection to the host computer 14.

Computer Software

The computer software resident on the computer 14 will preferably have the following functionality to allow various combinations of various combinations of or all of the following:

remote voice over IP access

standard answering machine and remote message retrieval

remote email retrieval from any phone line converting sender information to voice

remote data capture from websites, for example, stock quotes or other data

multi-language voice comments capability

remote control of local computer functions, for example, control of home security systems

The computer software includes the following modules amongst others to allow the above functionality:

1. Software Initialization Module

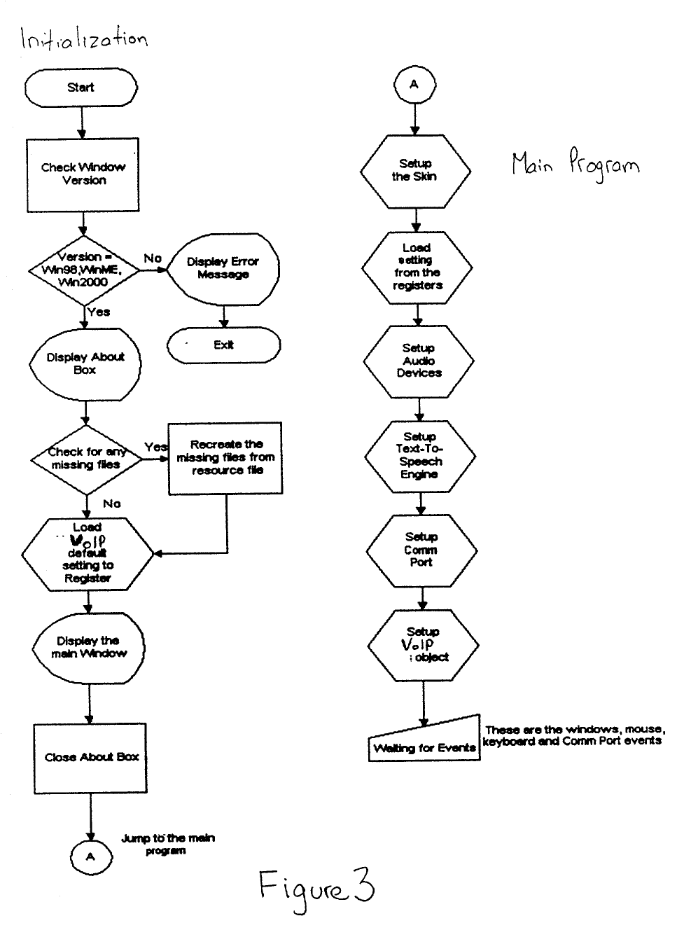

The computer software is resident on the host computer 14. At initialization (FIG. 3), the software determines the operating system software of the host computer. If the operating system is supported, the program proceeds to display an “about” window and checks for missing resource files. If there are no missing files or the missing files can be recreated from a resource file, the VoIP software default settings (described below) are loaded to the register. The main menu window is displayed and the about window is closed.

2. Main Program Module

The main program (FIG. 3) progresses sequentially with setting up the dynamic user interface (skin), loading settings from the registers, setting up audio devices, setting up the text-to-speech engine, setting up communication ports and setting up VoIP software. Upon setup, the main program enters a wait mode to wait for events to occur.

3. PCB Remote Access Module

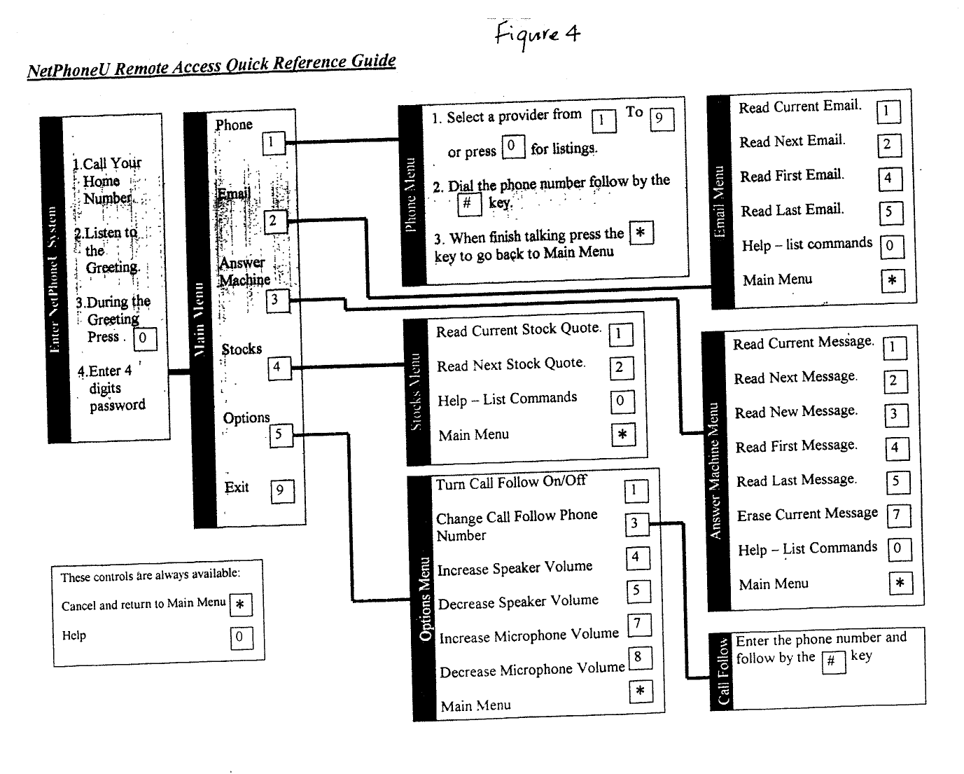

It is preferred that a user be able to remotely access the IP phone system functionality through a menu prompt and keypad response system, an embodiment of which is shown in FIG. 4.

In order to access the menu system, the user calls the local phone number assigned to local phone which would typically be the user's home or office number. Upon listening to a welcome greeting, the user is prompted to enter a key and password to enter the main menu of the system. In one embodiment, the main menu would include selections allowing the user to initiate an internet phone call, retrieve and listen to email messages, retrieve, listen and respond to voice mail messages, retrieve and listen to stock quotes as well as setting user options (FIG. 4).

4. Text-to-Speech Module

In one embodiment, the computer software includes a text-to-speech module for converting text files to an analog speech signal which is played to a user, thus allowing a user to listen to text files (such as emails) from a remote location. With reference to FIG. 4, if a user has selected a specific data file (email or stock quote in this example), the text file is spoken to the user. The text-to-speech module can include different languages. For example, an email may be sent to a user in English or Chinese, and accordingly, the speech to text-to-speech module can recognize the language and play the message in the language of the email.

5. Check Email Module

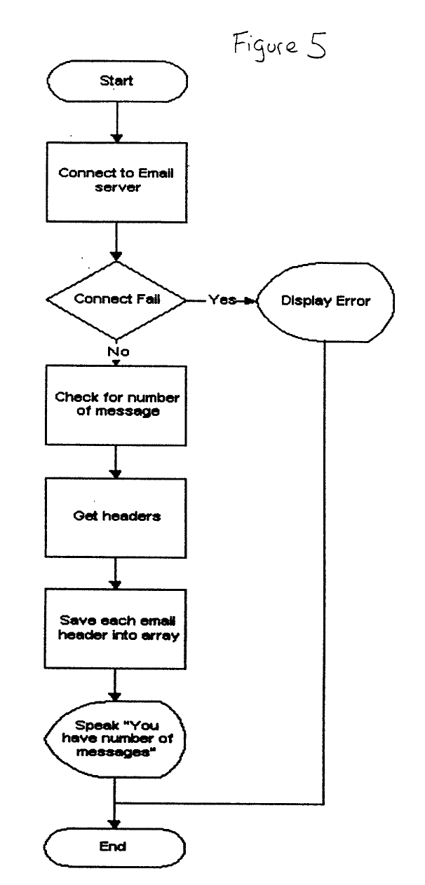

The check email module (FIG. 5) allows a user to locally or remotely check email messages. If checked locally (ie at computer 14), the user is able to directly read any email messages. If checked remotely (ie from remote phone 17), the check email module will determine the number of email messages and their headers or subjects and audibly tell the user the number of emails. The user may select to have an email read to them as managed by the text-to-speech module.

6. Incoming Telephone Calls

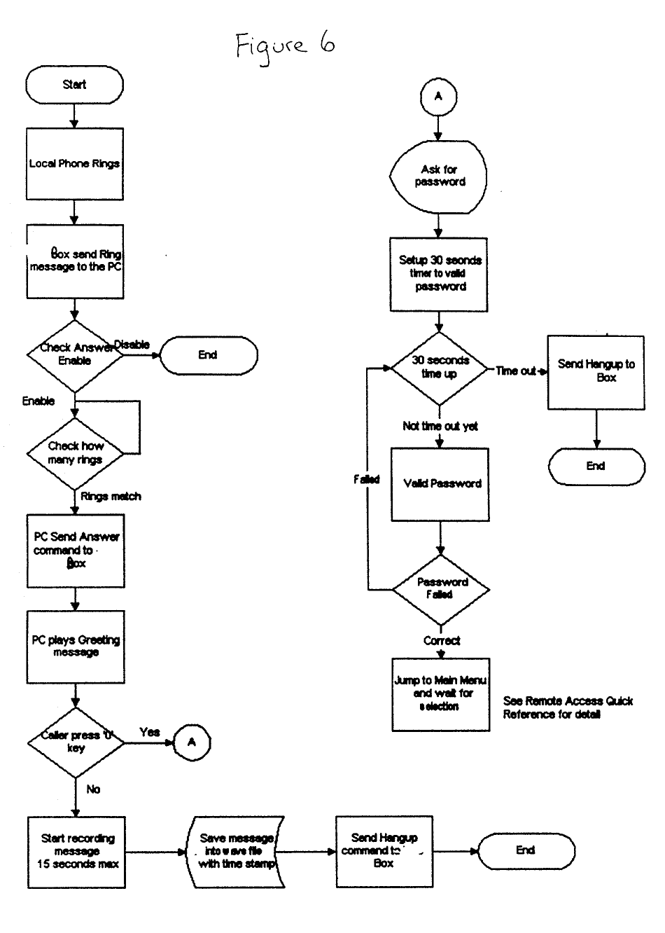

In the situation of an incoming call from a remote telephone to PCB 12 and computer 14 (FIG. 6), the following general protocol is followed. Initially, upon detecting the incoming call, the PCB 12 sends a ring signal to the computer 14 and checks if the system is answer enabled. If yes, the system will send an answer command to the PCB 12. If the system is not answered enabled, the routine ends and the caller would continue to hear ring tones. Upon answering the call, the computer 14 plays a greeting message to the caller and on completion requests the caller to enter a key (for example, “0”). If the caller enters the key, the system will prompt the user to enter a password, which upon authentication allows the caller to access the software protocols accessible through the main menu (FIG. 4).

If the entry key is not entered, the system will allow the caller to record a message which may be saved as a sound file with a time and date stamp and a hangup command to the PCB 12 will end the call.

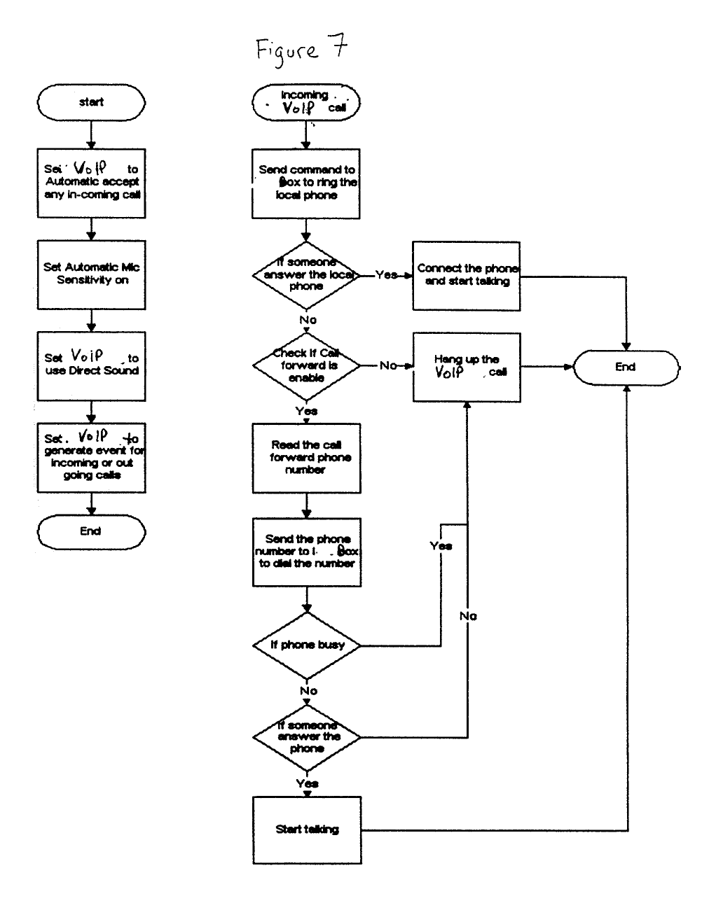

7. Voice Over IP Module (FIG. 7)

The VoIP module uses known voice over IP software, such as NETMEETING to manage VoIP incoming and outgoing calls. The VoIP software enables real-time audio and, preferably, real time video and data communications over the Internet using the H.323 audio and video conferencing standard, and the T.120 data conferencing standard. NETMEETING, for example, can be used to place calls and receive calls from products that are H.323 and T. 120 compatible. With appropriate equipment and services from third parties, the VoIP software can place a call to a telephone using an H.323 gateway and place calls to H.323 multipoint conferencing units (MCUs) and participate in multipoint audio/video conferences.

The typical workflow is shown in FIG. 7. At the start, the VoIP software will set parameters which manage the incoming and outgoing calls.

If an incoming call is received, the VoIP software will send a command to the IP phone controller box to ring the local phone. If the phone is answered, the call is connected and the participants can talk. If the phone is not answered, the system will check if call forward is enabled and, if so, the software will read the call forward number and send the call forward number to IP phone controller to dial the number. If the dialled number is answered, the connection is made and the participants can talk. Alternatively, if the call forward is not enabled or the call forward number phone is not answered, the VoIP call is ended.

8. Setup Communication Port

Serial port communication between the IP Phone Controller and the computer is controlled using known communication software. For example, MICROSOFT COMMUNICATION ACTIVEX CONTROL can be used to control the serial port communication between the IP Phone Controller and the computer software. For example, to dial a phone number, the software will send a “Dial” command to the serial port and the IP Phone controller will switch to the local phone line and dial the number. As another example, whenever the phone rings, the IP phone controller will send a “Ring” command back to the serial port and the software will then pick up the call and start processing.

9. System Networking

The system can work in either a dial-up network or high speed internet (ADSL or Cable), as long as the network provides TCPIP protocol.

System Requirements

In its present form the following list is representative of computer system requirements. It is understood that this list is not intended to be limiting to the hardware which may be implemented to support the system as would be understood by one skilled in the art.

Pentium class processor (minimum 200 MHz)

Windows 98, Windows 98SE, Windows ME and Windows 2000

64 MB RAM

20 MB of available hard disk space

Colour monitor with 256 colour (8-bit) or greater video card

800x600 or greater monitor resolution

CD-ROM drive

RS232 serial port

Sound-Blaster compatibles sound card

Internet access (minimum 28.8 kbps)

extra phone line for remote access (optional)

Technical Support

It is also understood that the system may be deployed with technical support capabilities allowing a user to obtain technical support using the phone system or internet. Technical support may include 24/7 call center to handle all billing and technical inquiries, Web based technical support and/or web based upgrade downloads for system software.

We claim:

1. A communications system enabling voice communications over the internet between a local or remote phone and a destination phone comprising:
an internet protocol (IP) phone controller for operative connection to the local and remote phone and a computer operatively connected to the internet, the computer having communications software for managing voice over internet protocol communications between the local and remote phone and a destination phone through the phone controller.

2. A communications system as in claim 1 wherein the remote phone is connected to the IP phone controller by a wired or wireless link.

3. A communications system as in claim 1 wherein the destination phone is any one of a local or remote phone operatively connected to a destination IP phone controller and destination computer operatively connected to the internet or a wireless or wired destination phone operatively connected to the internet through a public switched telephone network.

4. A communications system as in claim 1 wherein the communications software includes a menu system for selecting an internet phone provider.

5. A communications system as in claim 4 wherein the user dials a destination number after selection of an internet phone provider.

6. A communications system as in claim 1 wherein the communications software enables accessing internet data.

7. A communications system as in claim 6 wherein the communications software includes a menu system for accessing internet data and the communications software enables formatting of the data for delivery of the data to the user.

8. A communications system as in claim 6 wherein the communications software enables delivery of the data to the user via a text-to-speech module.

9. A communication system as in claim 6 wherein the internet data is email.

10. A communications system as in claim 2 wherein the destination phone is any one of a local or remote phone operatively connected to a destination IP phone controller and destination computer operatively connected to the internet or a wireless or wired destination phone operatively connected to the internet through a public switched telephone network.

11. A communications system as in claim 10 wherein the communications software includes a menu system for selecting an internet phone provider.

12. A communications system as in claim 11 wherein the user dials a destination number after selection of an internet phone provider.

13. A communications system as in claim 12 wherein the communications software enables accessing internet data.

14. A communications system as in claim 13 wherein the communications software includes a menu system for accessing internet data and the communications software enables formatting of the data for delivery of the data to the user.

15. A communications system as in claim 14 wherein the communications software enables delivery of the data to the user via a text-to-speech module.

16. A communication system as in claim 15 wherein the internet data is email.

17. A method for making a voice over internet protocol telephone call to a destination number from a remote telephone comprising the steps of:
(a) dialling a phone number for an internet protocol (IP) phone controller operatively connected to a computer and the internet;
(b) accessing an internet phone provider through the IP phone controller and computer; and,
(c) dialling the destination number from the remote telephone.

18. A method for obtaining internet data from a remote telephone comprising the steps of:
(a) dialling a phone number for an internet protocol (IP) phone controller operatively connected to a computer and the internet;
(b) accessing an internet data provider through the IP phone controller and computer; and,
(c) instructing the internet data provider to download data to the computer.

19. A method as in claim 18 further comprising the step of formatting the downloaded data to a user selected format for delivery to the remote phone.

20. A method as in claim 19 where the data is delivered to the user as analog speech.

21. A communications system enabling voice communications over the internet between a local or remote phone and a destination phone comprising:
an internet protocol (IP) phone controller for operative connection to the local and remote phone;
a computer operatively connected to the internet, the computer having communications software for managing voice over internet protocol communications between the local and remote phone and a destination phone through the phone controller, the communications software having:
a menu system module, the menu system module enabling a user to select an internet phone provider and to dial a destination number after selection of an internet phone provider;
access to formatted internet data and delivery of the data to the user via a text-to-speech module,
wherein the destination phone is any one of a local or remote phone operatively connected to a destination IP phone controller and destination computer operatively connected to the internet or a wireless or wired destination phone operatively connected to the internet through a public switched telephone network.
